(19) United States
(12) Patent Application Publication
(10) Pub. No.: US 2002/0038427 A1
(43) Pub. Date: Mar. 28, 2002

(54) Biometric device

(76) Inventor: Michael F. Krieger, Salt Lake City, UT (US)

Correspondence Address: Michael F. Krieger, Kirton & McConkie, 1800 Eagle Gate Tower, 60 East South Temple, Salt Lake City, UT, 84111, US

(21) Appl. No.: 09/963,867

(22) Filed: Sep. 26, 2001

Related U.S. Application Data
(60) Provisional application No. 60/236,256, filed on Sep. 28, 2000.

(51) Int. Cl. H04L 9/00

(52) U.S. Cl. 713/186

(57) ABSTRACT

An apparatus and method are provided to prevent unauthorized access to a software application, a computer network, or an individual computer. The apparatus stores the biometric signal of an authorized user, and compares it with the biometric signal from the individual attempting to access the software or network and then either allows access to that software or network or denies access.

### RELATED APPLICATIONS

This application claims priority to provisional application 60/236,256, filed Sep. 28, 2000.

### FIELD OF THE INVENTION

### Background Art

The present invention is directed to a method and apparatus for controlling access to software applications. More specifically, a method is provided wherein registered user authentication occurs through comparing a stored biometric signal against a current biometric signal to determine whether the individual holding a computer control device is authorized to access to the software application. An apparatus is also provided to obtain a current biometric signal from a user and present that for comparison with a stored biometric signal.

### BACKGROUND

Presently, software applications are often registered with the manufacturer or retailer soon after purchase. The purchase of this registration is to provide the manufacturer or distributor with personal information regarding the purchaser so that support services can be provided to the appropriate individual. Registration also ensures that those who should not be licensed to use the software cannot receive free support, upgrades, etc. and so that subsequent audits can be conducted to determine whether the number of users within an organization exceeds the current number of licenses.

A shortfall of the current registration system, however, occurs when multiple copies of the software are created. If these copies are not registered, and no support is ever requested by the elicit users of the software, then the manufacturer or retailer cannot control the licensing of the software and will not receive royalties from its use. If the illicit use becomes prolific, it can place a great financial strain on the software company relying on the stream of royalties to maintain its research and development and sales forces.

### OBJECTS AND SUMMARY OF THE INVENTION

The present invention prevents illicit use of copied software by requiring that a current biometric signal is obtained and compared to a stored signal prior to activation of the software upon initial start-up, a baseline biometric signal is obtained. This biometric signal is then stored and compared to the individual attempting to access the software. If this comparison is successful, then the user is allowed access. If the comparison is unsuccessful, then the user is denied access thereby limiting use of a software application to one individual. The present invention limits the acquisition of the biometric signal to one occurrence so that elicit copiers may not simply enter their biometric signals into the misappropriated software. In order to acquire the first biometric signal and subsequent biometric signals, a computer control device such as a mouse is provided which has ergonomically located sections through which a biometric signal can be naturally and easily acquired.

### BRIEF DESCRIPTION OF THE DRAWINGS

FIG. 1 illustrates a mouse having an area on its side where the thumb naturally rests when a user is holding a mouse;

FIG. 2 illustrates the same mouse with the hand of the user in a natural position on the mouse; and

FIG. 3 illustrates another embodiment of the mouse having an opening on the top where one of the fingers of the user naturally rests.

### DETAILED DESCRIPTION OF PREFERRED EMBODIMENTS

Referring first to FIG. 1, a computer control device such as a mouse is presented having an opening covered by a transparent material allowing a biometric signal to be acquired through the transparent material from inside the mouse. The biometric signal acquired can be a thumb print or other biometric viewable through the opening of the mouse.

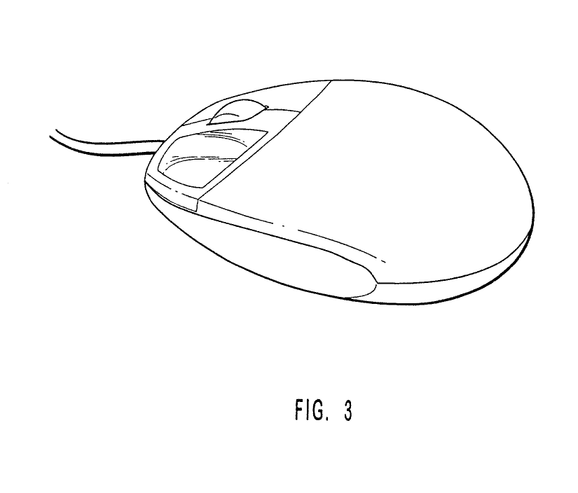

For example, as shown in FIG. 3 the opening in the mouse may be located at the top of the mouse or some other control device so that it is located in a position where the finger naturally rests when the mouse or the control device is being controlled. The opening is placed in a position where the hand naturally rests so that the user will not be inconvenienced during the authentication process and so that multiple authentication processes may occur some even while the user is working in other software applications also requiring a mouse or other control device for their functionality.

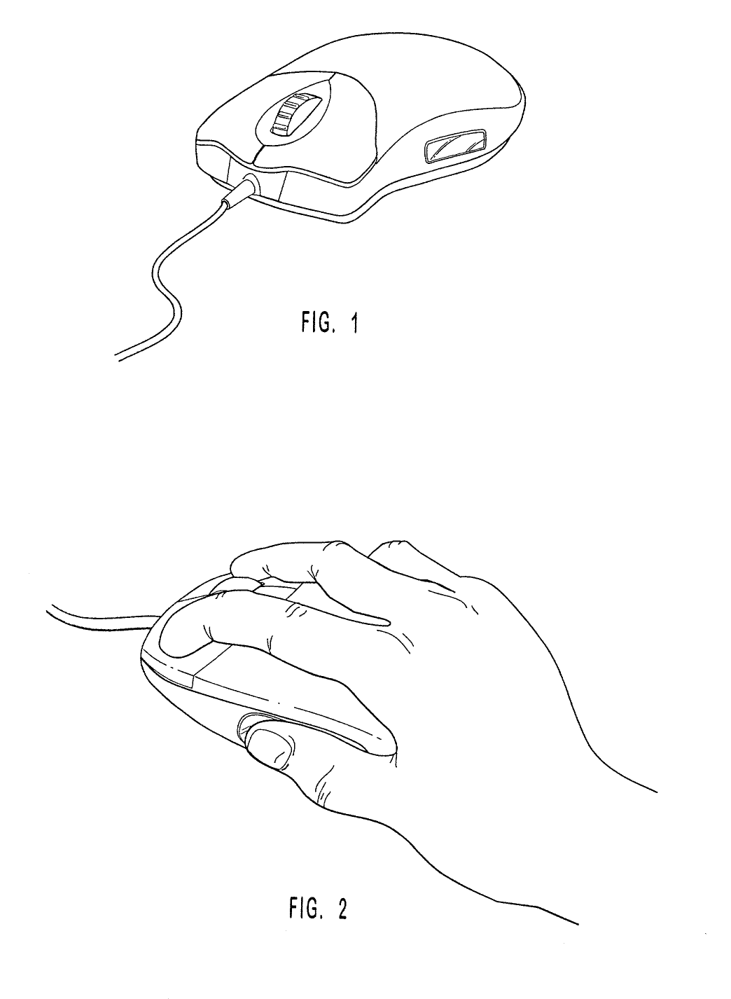

As can be seen in FIG. 2, the location of the openings through which the biometric signal is acquired are located in positions where the hand naturally falls. It will be appreciated at the location of the opening can be varied depending on the control device, and the right or left handedness of the user. The acquisition of the biometric can be made through any of the known thumb print and finger print scanning technologies.

Turning now to the method of authentication of the present invention, the software interface is utilized to present access to a software application prior to authentication of the user. This interface may be incorporated as part of the start-up procedure for a computer operating system so that all programs are protected by the interface, or may be interposed only for some software programs available on the program. The interface may also be incorporated by manufacturers into the software program itself. For example, while it will be most beneficial and preferential for a software manufacturer to incorporate the interface into the software itself, large organizations wishing to protect themselves from illicit copying of their software may also wish to interpose the interface on several software programs not incorporating the interface within their code. In addition, the present invention may be utilized by individuals wishing to protect access to their computer by preventing any unauthorized or unauthenticated access by using the present invention in the initial stages of the startup routine in their computer. The interface, upon first activation, requires an initial biometric to be submitted by the user. This initial biometric may be acquired through the apparatus of the present invention or may be provided by other biometric acquisition technics or devices. Whatever the method for acquisition, however, the signal must be compatible with the signal generated by the acquisition device which will be used during the initiation of the software application at a later date. As long as the formats are compatible, the signal may be acquired through any number of known in later-developed technics. After successful acquisition of the signal, the signal is then stored in the interface for future comparison. In order to allow for natural variations in the biometric of the user, the present invention also anticipates that three or four biometric signals may be acquired from the user upon initiation of the interface so that some variation will be allowed in future comparisons.

Upon subsequent activation of a software program, the interface will request that the user provide a current biometric signal by placing the thumb or finger on the location on the control device. This current biometric signal will then be compared with the stored signal to authenticate the identification of the user. If the comparison is successful, then access to the software application is allowed. If the verification is unsuccessful, then the user will be denied access to the software application. If desired, the method also anticipates that a message can be sent via email or telephonically to the registered user of the computer indicating that an inappropriate access was attempted. The application also anticipates that the biometric signal received from the individual who was attempting to inappropriately access the computer can be stored and used to later identify that individual. For example, in a local area network setting, the main server can have on record the biometrics of all the employees within the organization. This server can then store the biometric of individuals accessing various programs, and can present a report to the manager of the network. The manager can then identify which individuals have either been attempting to inappropriately access certain software, or may determine the access habits of those who have appropriately been accessing the software.

Since the present invention obviates the need for passwords, and the problems associated with forgetting several different passwords, and also prevents the illicit use of someone else's password to misidentify someone trying to access the computer, security is greatly increased. In addition, if the interface of the present invention is incorporated into the software when the software is sold, a software manufacturer can prevent access to illicit copies of the software by forcing users of the software to purchase their own copy, many of the piracy problems plaguing software manufacturers can be prevented.

What is claimed:

1. A control device for authenticating the identification of a user prior to access to a software application, the control device comprising:
a) a biometric signal acquisition module;
b) an area on the acquisition device through which the biometric acquisition module may obtain the biometric signal of a user of the control device; and
c) a software interface for preventing access to a software application by unauthorized users.

2. A method for preventing access to a software application the method comprising the steps of obtaining a base line biometric signal from an authorized user; (b) obtaining a current biometric signal from the current user attempting to access the software; (c) comparing the current biometric signal with the baseline biometric signal to determine whether the user is authorized to access the software; and (d) allowing access to the software if the comparison reveals that the current user is authorized to access the software.

3. A method for providing security to a network of computers, the method comprising of steps of (a) obtaining base line biometric signals for all authorized users of a network; (b) providing a biometric acquisition device at the location of each of the authorized users; (c) obtaining a current biometric signal from an individual attempting to access the network; (d) comparing the current biometric signal with the stored baseline biometric signal to determine whether the current user is authorized to access the network; and (e) allowing access to the network if the user is authorized.

4. The method set forth in the claim 3 above further comprising the step of denying access to the network if the current user is not authorized.

5. The method set forth in the claim 3 above further comprising the step of storing the biometric from an unauthorized user attempting to access the network and providing that biometric to the manager of the network.
